(19) United States
(12) Patent Application Publication
(10) Pub. No.: US 2008/0187049 A1
(43) Pub. Date: Aug. 7, 2008

(54) Moving image encoding device and moving image encoding method

(75) Inventors: Masayuki Tokumitsu, Kyoto (JP); Satoshi Nakagawa, Osaka (JP)

Correspondence Address: RABIN & Berdo, PC, 1101 14TH STREET, NW, SUITE 500, WASHINGTON, DC, 20005, US

(73) Assignee: OKI ELECTRONIC INDUSTRY CO., LTD., TOKYO (JP)

(21) Appl. No.: 12/003,172

(22) Filed: Dec. 20, 2007

(30) Foreign Application Priority Data
Feb. 6, 2007 (JP) 2007-027032

(51) Int. Cl. H04N 7/32

(52) U.S. Cl. 375/240.16; 375/240.12; 375/E07.123

(57) ABSTRACT

A moving image encoding device that encodes a difference between a predicted image and an original image is provided. The predicted image is generated using a weighted reference image, for which a weight is multiplied with and an offset is added to a reference image. The moving image encoding device includes an image data reduction section and a weighting estimation section. The image data reduction section reduces data volumes of the original image and the reference image while retaining characteristics of the original image and the reference image. The weighting estimation section estimates weighting parameters on the basis of image data of the original image and reference image of which the data volumes have been reduced by the image data reduction section.

### CROSS-REFERENCE TO RELATED APPLICATION

This application claims priority under 35 USC 119 from Japanese Patent Application No. 2007-027032, the disclosure of which is incorporated by reference herein.

### BACKGROUND OF THE INVENTION

1. Field of the Invention

The present invention relates to a moving image encoding device and a moving image encoding method that perform encoding of a moving image using interframe differences.

2. Description of the Related Art

In a moving image encoding system that encodes differences between a predicted image and an original image, as a technology which applies a weight and adds an offset to a predicted image, and a technology which takes differences from the original image and encodes the same, there are technologies such as that illustrated in Japanese National Publication No. 2006-509467.

In Japanese National Publication No. 2006-509467, if pixel values of an original image are X[i], and pixel values of a predicted image are Y[i], then

X[i]−(W*Y[i]+T)

is encoded.

It is a well-known fact among those having specialist knowledge in this field that a compression rate is high when this value is close to zero.

Furthermore, it is clear that setting suitable values for W and T is important for raising the compression ratio.

In an example described in Japanese National Publication No. 2006-509467, W is found as in the following expression.

W=AVE[X[i]]/AVE[Y[i]]

In a case in which X[i] and Y[i] have a positive correlation as shown in FIG. 4 and a distribution thereof runs along a linear form passing through the origin point, the W determined from the above expression is effective for making values of X[i]−(W*Y[i]+T) smaller. In such a case, T=0.

It is also possible to more accurately find a weighting by employing a motion vector and performing motion compensation using a standard image to which a weighting has not been applied (a reference image) to obtain a motion-compensated image mcref, and similarly finding a weight W which is W=AVE[X[i]]/AVE[Y[i]] with the motion-compensated image mcref as Y[i] and an encoding object image cur as X[i].

Accordingly, it is possible to encode effectively in cases of fades.

However, a problem arises if a distribution of x[i] and y[i] is not along a line passing through the origin point. FIG. 5 shows an example thereof.

If the distribution is along a form ax+b (b>0), then at a portion around x=(x_min+x_max)/2, values of y−(w*x+t) are small, but in the vicinities of x=x_min and x=x_max, values of y−(w*x+t) are large, and encoding volumes are increased.

Thus, there is a problem in that encoding volumes increase regardless of time being taken specifically for calculating weightings.

### SUMMARY OF THE INVENTION

The present invention has been devised in order to solve the problem described above, and is characterized by a moving image encoding device that encodes a difference between a predicted image and an original image, the predicted image being generated using a weighted reference image, for which a weight is applied and an offset is added to a reference image, the moving image encoding device including: an image data reduction section that reduces data volumes of the original image and the reference image while retaining characteristics of the original image and the reference image; a first weighting estimation section that estimates weighting parameters on the basis of image data of the original image and reference image of which the data volumes have been reduced by the image data reduction section; a weighted motion vector search section that searches for a motion vector on the basis of the weighting parameters estimated by the first weighting estimation section and at least one of the original image and reference image which have been reduced by the image data reduction section and the original image and reference image prior to being reduced; a motion compensation section that generates a motion-compensated image using the motion vector searched for by the weighted motion vector search section and the reference image; and a second weighting estimation section that estimates weighting parameters from the motion-compensated image generated by the motion compensation section and the original image.

Accordingly, when a motion vector search is performed in order to find a motion vector to be used by the motion compensation section, a high-precision motion vector search is carried out by performing a weighted motion vector search. Thus, weighting parameters that are found using the results thereof are accurate.

Further, another structure is characterized in using a least squares method in weighting estimation. Accordingly, precision of weighting estimations is improved and weighting parameters can be found accurately.

Furthermore, a moving image encoding method includes a constitution similar to the functions of the sections of the moving image encoding device.

With this moving image encoding method, similarly to the moving image encoding device, data volumes of the original image and reference image are reduced, and processing for weighting estimation and the like is performed.

A first effect of this solution is that, because weighting parameters are found accurately, differences between a weighted motion-compensated image and an original image are smaller, and encoding results are correspondingly smaller. Moreover, because data volumes of the original image and reference image are reduceed before the processing for weighting estimation and the like is performed, a magnitude of data to be processed can be made smaller, and a reduction in processing volume and a shortening of processing time can be achieved.

A second effect of this solution, in addition to the first effect of the solution, is that, because weighting parameters are found accurately, differences between a weighted motion-compensated image and an original image are smaller, and encoding results are correspondingly smaller.

### BRIEF DESCRIPTION OF THE DRAWINGS

FIG. 1 is a schematic structural diagram showing a moving image encoding device relating to a first embodiment of the present invention.

FIG. 2 is a schematic structural diagram showing a moving image encoding device relating to a second embodiment of the present invention.

FIG. 3 is a schematic structural diagram showing a moving image encoding device relating to a third embodiment of the present invention.

FIG. 4 is a graph showing a correlation.

FIG. 5 is a graph showing a correlation.

FIG. 6 is a graph showing a case in which a correlation is negative.

FIG. 7 is a functional block diagram showing a moving image encoding device for realizing a moving image encoding method relating to a fourth embodiment of the present invention.

FIG. 8 is a functional block diagram showing a moving image encoding device for realizing a moving image encoding method relating to a fifth embodiment.

### DETAILED DESCRIPTION OF THE INVENTION

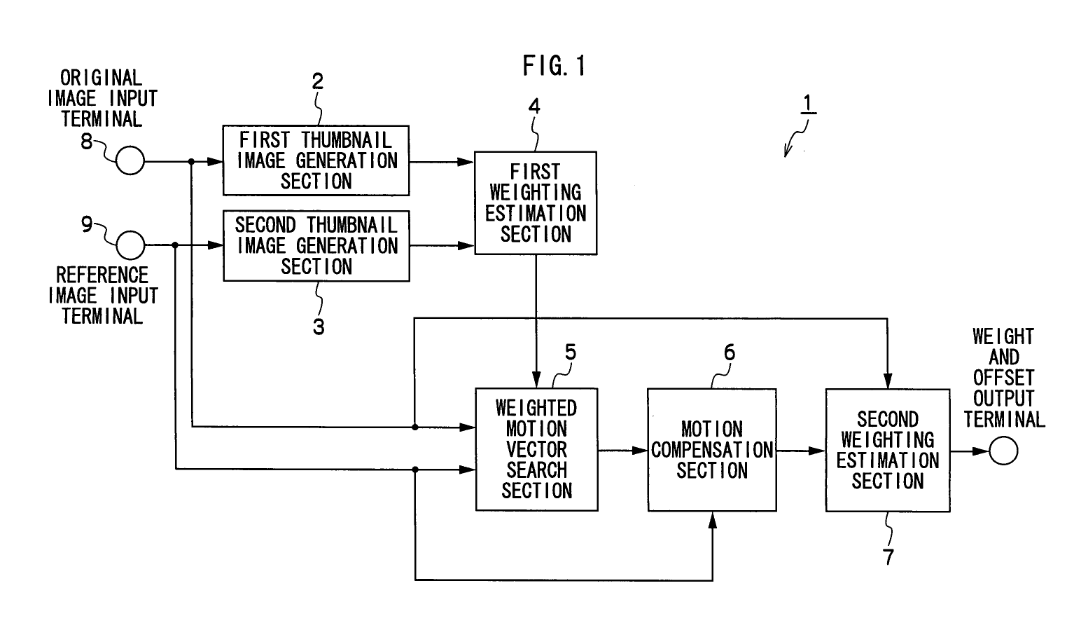

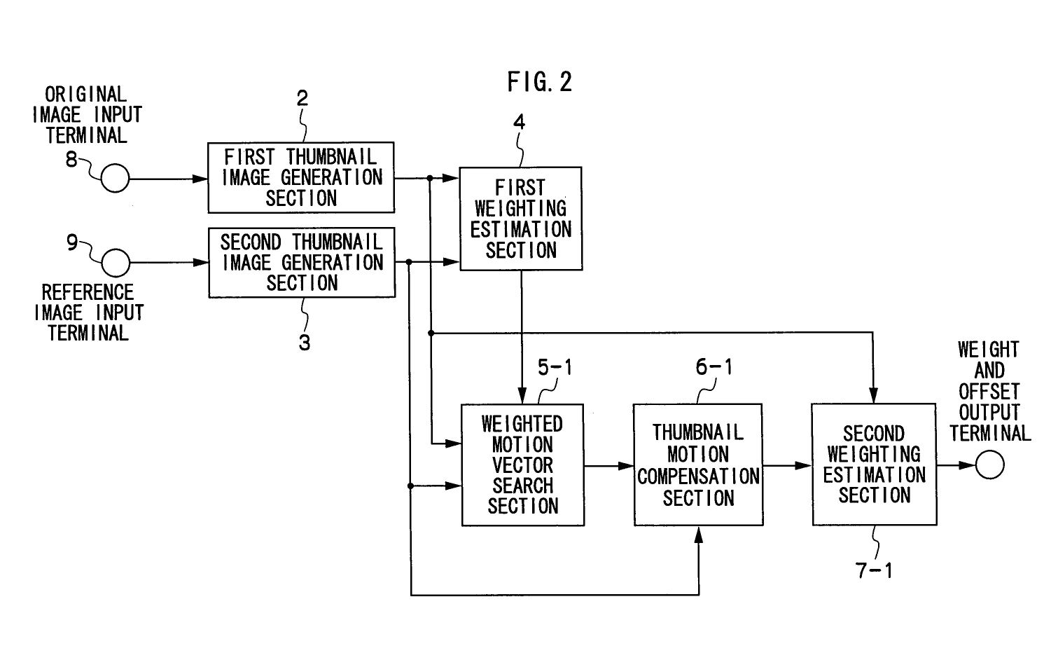

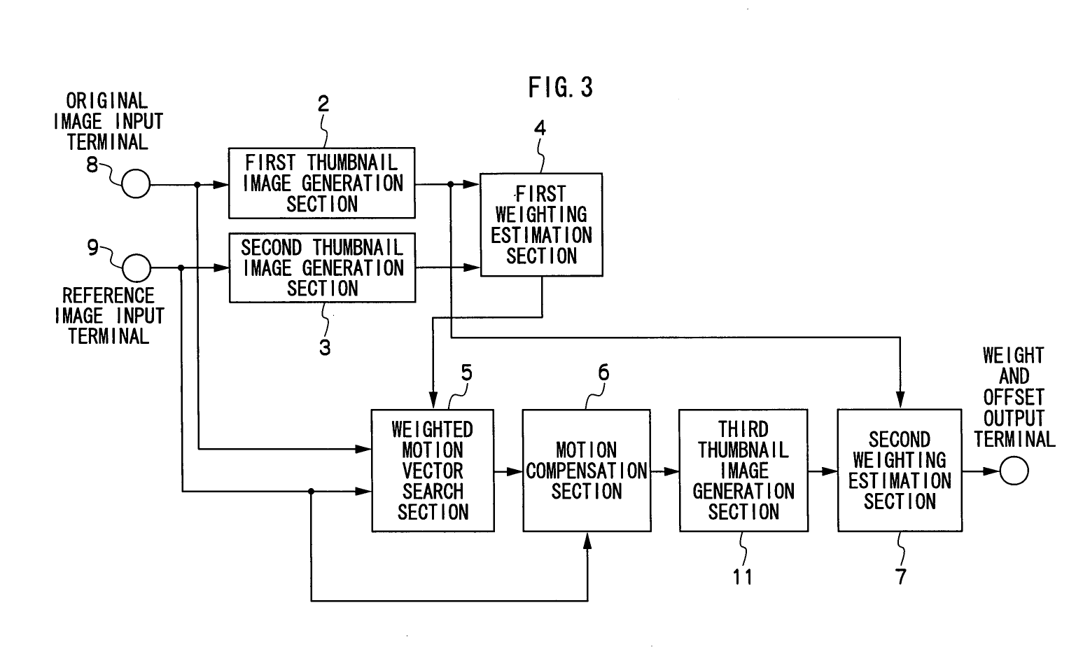

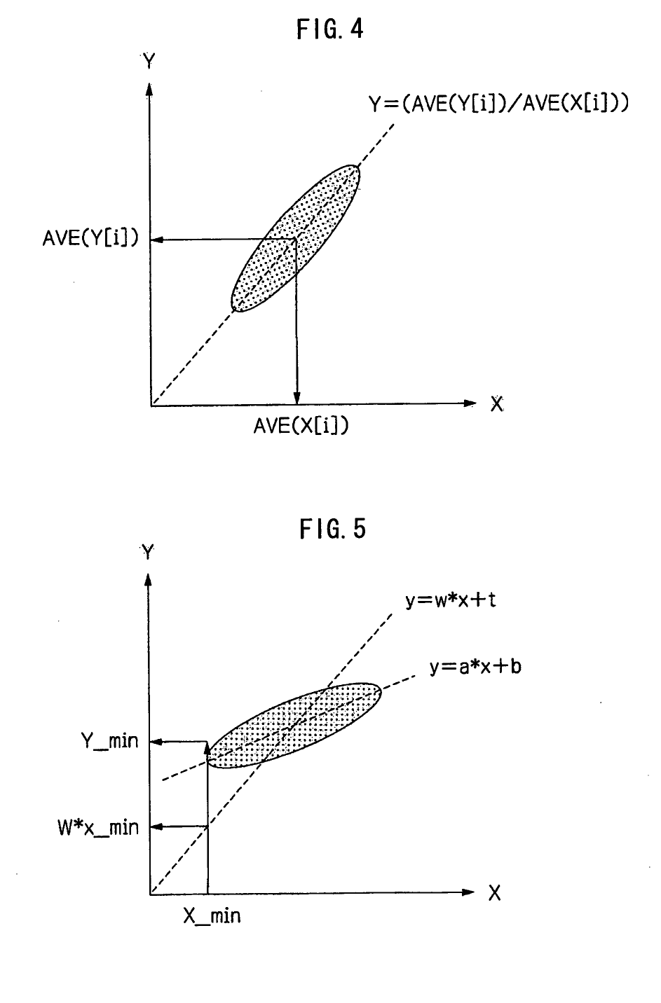

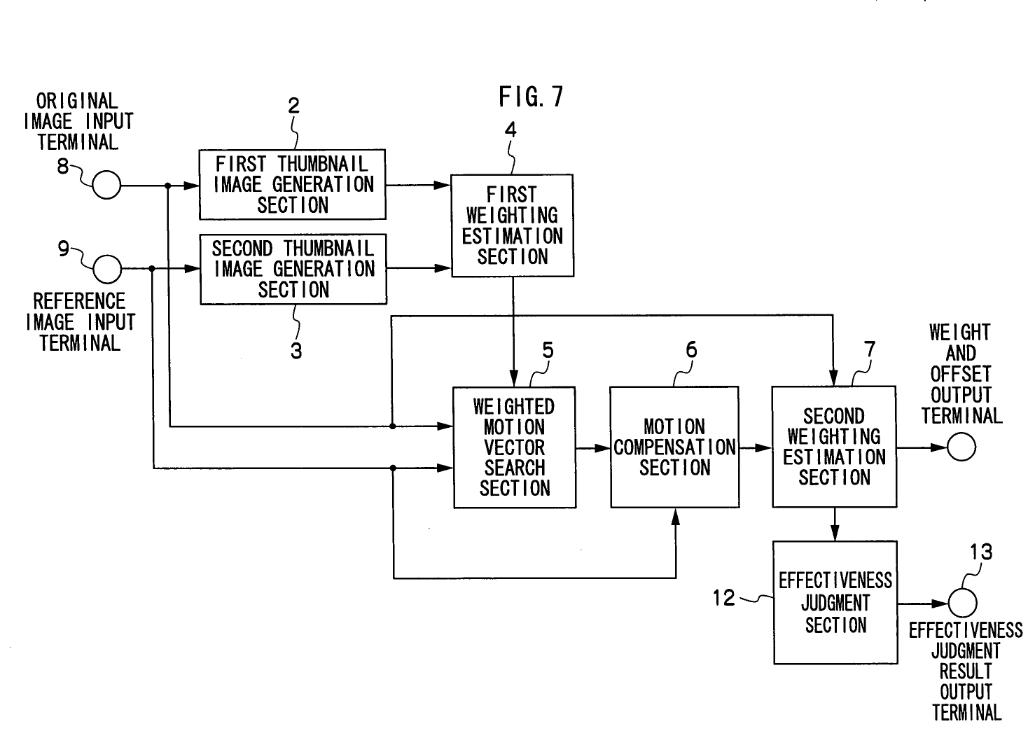

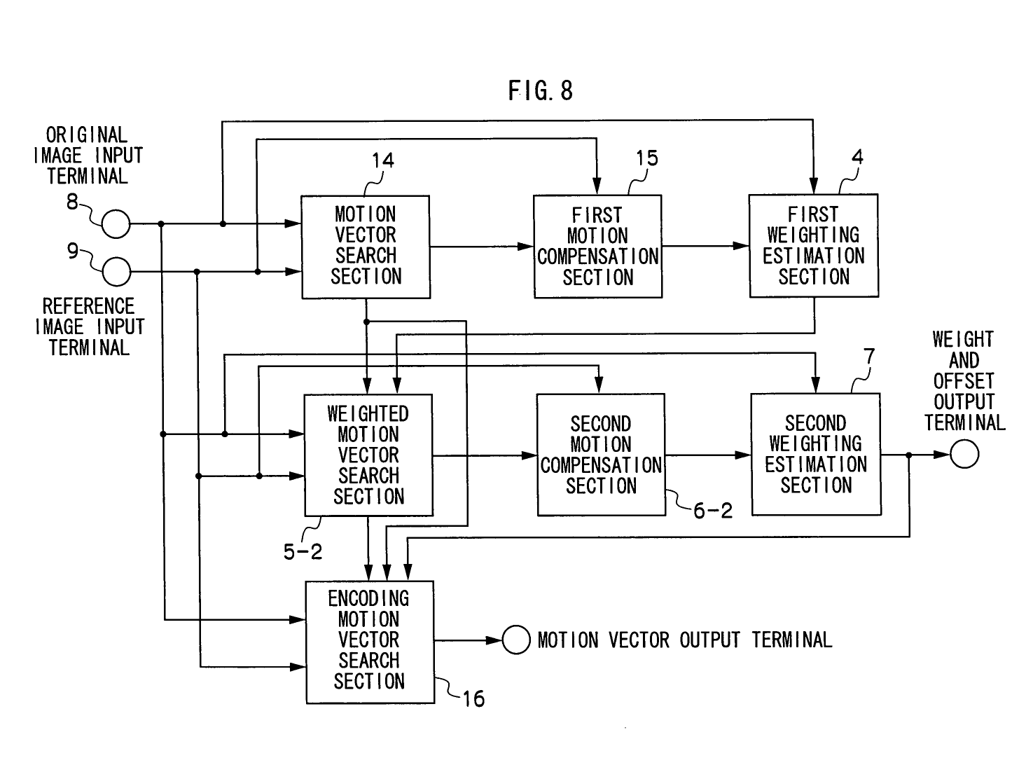

Herebelow, moving image encoding devices and moving image encoding methods relating to embodiments of the present invention will be described on the basis of the attached drawings. FIG. 1 is a functional block diagram showing a moving image encoding device for realizing a moving image encoding method relating to a first embodiment. FIG. 2 is a functional block diagram showing a moving image encoding device for realizing a moving image encoding method relating to a second embodiment. FIG. 3 is a functional block diagram showing a moving image encoding device for realizing a moving image encoding method relating to a third embodiment. FIG. 7 is a functional block diagram showing a moving image encoding device for realizing a moving image encoding method relating to a fourth embodiment. FIG. 8 is a functional block diagram showing a moving image encoding device for realizing a moving image encoding method relating to a fifth embodiment.

### First Embodiment

The moving image encoding device and moving image encoding method relating to the first embodiment will be described on the basis of FIG. 1. The moving image encoding device and moving image encoding method relating to the present embodiment, when an original image and a reference image are inputted, ultimately output a weight and an offset.

A moving image encoding device 1 is structured with a first thumbnail image generation section 2, a second thumbnail image generation section 3, a first weighting estimation section 4, a weighted motion vector search section 5, a motion compensation section 6 and a second weighting estimation section 7. Herebelow, structures of the sections will be described in accordance with a sequence in which image data is inputted thereto.

A compression object original image is inputted through an original image input terminal 8 to the first thumbnail image generation section 2. The first thumbnail image generation section 2 is an image data reduction section which reduces a data volume of the original image while retaining characteristics of the original image. The original image which has been inputted to the first thumbnail image generation section 2 is reduced and then sent from the first thumbnail image generation section 2 to each of the first weighting estimation section 4, the weighted motion vector search section 5, the motion compensation section 6 and the second weighting estimation section 7, and is subjected to processing by each section. The compression object original image is inputted from the original image input terminal 8 both to the first thumbnail image generation section 2 and to the weighted motion vector search section 5 and the second weighting estimation section 7.

Meanwhile, a reference image is inputted through a reference image input terminal 9 to the second thumbnail image generation section 3. The second thumbnail image generation section 3 is an image data reduction section which reduces a data volume of the reference image while retaining characteristics of the original image. The reference image which has been inputted to the second thumbnail image generation section 3 is sent from the second thumbnail image generation section 3 to each of the first weighting estimation section 4, the weighted motion vector search section 5, the motion compensation section 6 and the second weighting estimation section 7, and is subjected to processing by each section. The reference image is inputted from the reference image input terminal 9 both to the second thumbnail image generation section 3 and to the weighted motion vector search section 5 and the motion compensation section 6.

Below, specific processing at each section will be described.

The first thumbnail image generation section 2 and the second thumbnail image generation section 3 are equipped with the following processing functions.

The original image inputted from the original image input terminal 8 is sent to the first thumbnail image generation section 2. The first thumbnail image generation section 2 reduces the original image, forming a thumbnail original image, and sends this to the first weighting estimation section 4.

The reference image inputted from the reference image input terminal 9 is sent to the second thumbnail image generation section 3. The second thumbnail image generation section 3 reduces the reference image, forming a thumbnail reference image, and sends this to the first weighting estimation section 4.

The first weighting estimation section 4 is equipped with the following processing functions.

The first weighting estimation section 4 receives the thumbnail original image from the first thumbnail image generation section 2, and receives the thumbnail reference image from the second thumbnail image generation section 3. The first weighting estimation section 4 uses the thumbnail original image and thumbnail reference image received from the first thumbnail image generation section 2 and second thumbnail image generation section 3 to estimate weighting parameters (a weight and an offset). Specific processing will be described later. Then, the first weighting estimation section 4 sends the estimated weight and offset to the weighted motion vector search section 5.

The weighted motion vector search section 5 is equipped with the following processing functions.

The weighted motion vector search section 5 performs a search for a motion vector of the original image with respect to the reference image. The weighted motion vector search section 5 receives the original image from the original image input terminal 8 and receives the reference image from the reference image input terminal 9, and also receives the estimated values of weight and offset from the first weighting estimation section 4. The weighted motion vector search section 5 searches for the motion vector on the basis of this data, and outputs a motion vector resulting from the search to the motion compensation section 6.

The motion compensation section 6 is equipped with the following processing functions.

The motion compensation section 6 uses the reference image and the motion vector to generate a motion-compensated image. The motion compensation section 6 receives the reference image from the reference image input terminal 9 and receives the motion vector from the weighted motion vector search section 5. The motion compensation section 6 generates the motion-compensated image from the reference image and the motion vector, and outputs the motion-compensated image to the second weighting estimation section 7.

The second weighting estimation section 7 is equipped with the following processing functions.

The second weighting estimation section 7 receives the motion-compensated image from the motion compensation section 6 and receives the original image from the original image input terminal 8. The second weighting estimation section 7 finds a weight and an offset from the motion-compensated image and the original image. Specific processing will be described later. The second weighting estimation section 7 outputs the weight and the offset to a weight and offset output terminal.

Next, a moving image encoding method of the present invention will be described.

Firstly, a thumbnail image generation step is performed. The thumbnail image generation step is an image data reduction step which reduces data volumes of the original image and the reference image while retaining characteristics of the original image and the reference image. The image data is reduced into a state in which characteristics such as movement on a screen, changes in brightness and the like are retained. This generates the thumbnail original image and the thumbnail reference image at the first thumbnail image generation section 2 and the second thumbnail image generation section 3 on the basis of the original image and the reference image.

Next, a first weighting estimation step is performed. This approximately estimates a weight w0 and an offset t0 at the first weighting estimation section 4, using the thumbnail original image and the thumbnail reference image.

Next, a weighted motion vector search step is performed. Here, the weight w0 and offset t0 estimated by the first weighting estimation section 4, the original image from the original image input terminal 8 and the reference image from the reference image input terminal 9 are put into the weighted motion vector search section 5, and a search for a motion vector is performed using the weight w0 and offset t0, the original image and the reference image. Then, a motion vector that is found is outputted to the motion compensation section 6.

Next, a motion compensation step is performed. Here, the motion vector found by the weighted motion vector search section 5 and the reference image from the reference image input terminal 9 are put into the motion compensation section 6, and a motion-compensated image is generated from the motion vector and the reference image. Then, the motion-compensated image that has been generated is outputted to the second weighting estimation section 7.

Next, a second weighting estimation step is performed. Here, the motion-compensated image generated by the motion compensation section 6 and the original image from the original image input terminal 8 are put into the second weighting estimation section 7. From the motion-compensated image and the original image, a weight w1 and an offset t1 are found by the second weighting estimation section 7.

Next, detailed operations of the respective sections will be described below.

<The First Thumbnail Image Generation Section 2 and The Second Thumbnail Image Generation Section 3>

Processing for reducing input images is carried out at the first thumbnail image generation section 2 and the second thumbnail image generation section 3.

A sum is found for each set of m×m pixels in an input image, and this serves as one pixel of the reduced image. Thus, an image 1/m in height and width can be formed. For example, if m=4, an image ¼ of the height and width is generated.

<The First Weighting Estimation Section 4>

The following processing is performed at the first weighting estimation section 4.

If x[i] is an i-th pixel value of the thumbnail reference image inputted from the second thumbnail image generation section 3, and y[i] is an i-th pixel value of the thumbnail original image inputted from the first thumbnail image generation section 2, a relationship of expression (1) is to be considered.

Σ(((w0×x[i]+t0)−y[i])²) (1)

Here, Σ represents a sum over the range of the reduced image.

The relationship of expression (1) enables processing to find a weight w0 and an offset t0 which are minimal. A least squares method is used for this processing. Thus, w0 and t0 are found by expression (2), which is obtained from the least squares method.

$$( \begin{matrix}w 0 \\ t 0\end{matrix} ) = {( \begin{matrix}\overline{{x}^{2}} & \overline{x} \\ \overline{x} & n\end{matrix} )}^{- 1} ( \begin{matrix}\overline{xy} \\ \overline{y}\end{matrix} ) \qquad ( 2 )$$

Here, elements other than n in expression (2) are as follows.

$$\begin{matrix}\overline{{x}^{2}} = {\sum }_{i} {x}^{2} [ i ] & \overline{x} = {\sum }_{i} x [ i ] \\ \overline{xy} = {\sum }_{i} x [ i ] y [ i ] & \overline{y} = {\sum }_{i} y [ i ]\end{matrix}$$

However, if the condition of the following expression (3) applies, then w0 and t0 are as shown in expression (4).

$$\begin{matrix}n ( \overline{{x}^{2}} ) - {( \overline{x} )}^{2} = 0 & ( 3 ) \\ \begin{matrix}W 0 = 0 \\ t 0 = \frac{\overline{y}}{n} \\ ( n is the number of pixels\end{matrix} \} & ( 4 )\end{matrix}$$

Here, because the weight w0 and the offset t0 are found for the thumbnail images, an amount of data to be processed is reduced and faster processing is enabled.

Moreover, even if x[i] and y[i] are distributed as in FIG. 5, because the weight W0 and the offset t0 are found with a least squares method, they can be found accurately, and expression can be made smaller.

<The Weighted Motion Vector Search Section 5>

At the weighted motion vector search section 5, the weight w0 found by the first weighting estimation section 4 is multiplied with pixel values of the reference image inputted from the reference image input terminal 9, and the offset t0 is added thereto. Thus, a weighted reference image, which is the new pixel values, is prepared. Then, a motion vector from the original image, from the original image input terminal 8, is searched for in this new weighted reference image. For this motion vector search, existing technologies may be used.

<The Motion Compensation Section 6>

The motion compensation section 6 takes in the motion vector from the weighted motion vector search section 5 and the reference image from the reference image input terminal 9, and prepares a motion-compensated image from the motion vector and the reference image. For creation of this motion-compensated image, existing technologies may be used.

<The Second Weighting Estimation Section 7>

The second weighting estimation section 7 uses the original image from the original image input terminal 8 instead of the thumbnail original image from the first thumbnail image generation section 2, and uses the motion-compensated image from the motion compensation section 6 instead of the thumbnail reference image from the second thumbnail image generation section 3. The second weighting estimation section 7 finally finds a weight w1 and an offset t1, from the original image and the motion-compensated image, by processing similar to the processing of the first weighting estimation section 4.

—Effects—

According to the present embodiment as described above, thumbnail images of an original image and a reference image are generated by the first thumbnail image generation section 2 and the second thumbnail image generation section 3, and processing is performed on the basis of these thumbnail images. Thus, data sizes of object images to be handled by the first weighting estimation section 4 can be made smaller, a processing volume can be reduced, and a shortening of processing time can be expected.

Further, at the first weighting estimation section 4, because the least squares method is used, it is possible to predict the weight and offset accurately. Furthermore, because weighting estimation processing is performed in two stages, by the first weighting estimation section 4 and the second weighting estimation section 7, it is possible to predict the weight and offset more accurately.

Because the motion vector search at the weighted motion vector search section 5 is performed using a weight and offset predicted by the first weighting estimation section 4, a motion vector can be found more precisely when the weighting has been applied. Then, because a weight and offset are estimated from a motion-compensated image that is obtained after the motion vector search by the weighted motion vector search section 5, and from the original image from the original image input terminal 8, the weight and offset can be estimated with better precision.

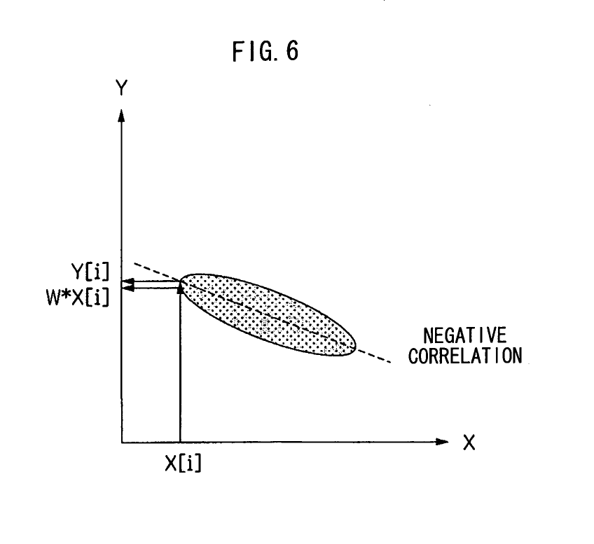

Further, because a suitable weight and offset can be found using the least squares method, this is applicable even to a case in which X[i] and Y[i] have a negative correlation, as shown in FIG. 6. A case of changes in an image such that light portions become darker and dark portions become lighter would have such a correlation. However, even in such a case, estimation with good precision is possible.

### Second Embodiment

Next, the moving image encoding device and moving image encoding method of the second embodiment will be described. In the present embodiment, inputs and outputs at the weighted motion vector search section 5, the motion compensation section 6 and the second weighting estimation section 7 differ from the first embodiment. Details of the present embodiment will be described below on the basis of FIG. 2. The moving image encoding device and moving image encoding method of the present embodiment, when an original image and a reference image are inputted, ultimately output a weight and an offset, similarly to the moving image encoding device and moving image encoding method of the first embodiment. Structure will be described in accordance with FIG. 2, in a sequence from the input side.

Similarly to the first embodiment, the original image input terminal 8 and the reference image input terminal 9 input a compression object original image and a reference image to be used during compression, respectively.

<The First Thumbnail Image Generation Section 2 and The Second Thumbnail Image Generation Section 3>

The original image inputted through the original image input terminal 8 is sent to the first thumbnail image generation section 2. At the first thumbnail image generation section 2, the original image is reduced, forming a thumbnail original image, and this is outputted to each of the first weighting estimation section 4, a weighted thumbnail motion vector search section 5-1, and a second weighting estimation section 7-1.

The reference image inputted through the reference image input terminal 9 is sent to the second thumbnail image generation section 3. At the second thumbnail image generation section 3, the reference image is reduced, forming a thumbnail reference image, and this is outputted to each of the first weighting estimation section 4, the weighted thumbnail motion vector search section 5-1, and a thumbnail motion compensation section 6-1.

<The First Weighting Estimation Section 4>

The first weighting estimation section 4 receives the thumbnail original image from the first thumbnail image generation section 2, and receives the thumbnail reference image from the second thumbnail image generation section 3. The first weighting estimation section 4 uses the received thumbnail original image and thumbnail reference image to estimate a weight and an offset, similarly to the first embodiment.

Then, the first weighting estimation section 4 sends the estimated weight and offset to the weighted thumbnail motion vector search section 5-1.

<The Weighted Thumbnail Motion Vector Search Section 5-1>

The weighted thumbnail motion vector search section 5-1 performs a search for a motion vector from the thumbnail original image to the thumbnail reference image. Differently from the first embodiment, the weighted thumbnail motion vector search section 5-1 receives the thumbnail original image from the first thumbnail image generation section 2 and receives the thumbnail reference image from the second thumbnail image generation section 3, and also receives the estimated values of weight and offset from the first weighting estimation section 4. The weighted thumbnail motion vector search section 5-1 searches for the motion vector on the basis of this data, and outputs a thumbnail motion vector resulting from the search to the thumbnail motion compensation section 6-1.

<The Thumbnail Motion Compensation Section 6-1>

The thumbnail motion compensation section 6-1 uses the thumbnail reference image and the thumbnail motion vector to generate a thumbnail motion-compensated image. The thumbnail motion compensation section 6-1 receives the thumbnail reference image from the second thumbnail image generation section 3 and receives the thumbnail motion vector from the weighted thumbnail motion vector search section 5-1. The thumbnail motion compensation section 6-1 generates the thumbnail motion-compensated image using the thumbnail reference image and the thumbnail motion vector, and outputs the thumbnail motion-compensated image to a second weighting estimation section 7-1.

<The Second Weighting Estimation Section 7-1>

The second weighting estimation section 7-1 receives the thumbnail motion-compensated image from the thumbnail motion compensation section 6-1 and receives the thumbnail original image from the first thumbnail image generation section 2. The second weighting estimation section 7-1 finds a weight and an offset from the received thumbnail motion-compensated image and thumbnail original image, and outputs this weight and offset to a weight and offset output terminal.

—Moving Image Encoding Method—

Processing for inputting the original image through the original image input terminal 8 to the first thumbnail image generation section 2 and generating the thumbnail original image at the first thumbnail image generation section 2 is the same as in the first embodiment, so will not be described.

Processing for inputting the reference image through the reference image input terminal 9 to the second thumbnail image generation section 3 and generating the thumbnail reference image at the second thumbnail image generation section 3 is the same as in the first embodiment, so will not be described here. Furthermore, processing at the first weighting estimation section 4 for inputting the thumbnail original image and the thumbnail reference image and outputting estimated values of a weight and offset is the same as in the first embodiment, so will not be described here.

<The Weighted Thumbnail Motion Vector Search Section 5-1>

Operations are the same as in the first embodiment but differ in that the thumbnail original image from the first thumbnail image generation section 2 is received instead of the original image from the original image input terminal 8 and the thumbnail reference image from the second thumbnail image generation section 3 is received instead of the reference image from the reference image input terminal 9. The weighted thumbnail motion vector search section 5-1 outputs a thumbnail motion vector that is found to the thumbnail motion compensation section 6-1.

<The Thumbnail Motion Compensation Section 6-1>

This thumbnail motion compensation section 6-1 performs operations the same as the motion compensation section 6 of the first embodiment but differs in receiving the thumbnail reference image from the second thumbnail image generation section 3, rather than the reference image from the reference image input terminal 9 being the input.

<The Second Weighting Estimation Section 7-1>

This basically performs operations the same as the second weighting estimation section 7 of the first embodiment, but differs from the first embodiment in that the original image from the original image input terminal 8 is replaced with the thumbnail original image from the first thumbnail image generation section 2.

Other operations are the same as in the first embodiment.

—Effects—

As described above, according to the second embodiment, data volumes of object images to be handled by the first weighting estimation section 4 can be made smaller by the processing of the first thumbnail image generation section 2 and the second thumbnail image generation section 3. Thus, a shortening of processing time can be expected.

Further, at the first weighting estimation section 4, because the least squares method is used, it is possible to predict the weight and offset accurately.

Because the motion vector search at the weighted thumbnail motion vector search section 5-1 is performed using a predicted weight and offset, a general movement when a moving portion is included in an image can be tracked.

At the weighted thumbnail motion vector search section 5-1, because the thumbnail original image from the first thumbnail image generation section 2 and the thumbnail reference image from the second thumbnail image generation section 3 are inputted, processing object image sizes are smaller, search processing is ameliorated, and a shortening of processing time is enabled.

Because a weight and offset are estimated at the second weighting estimation section 7-1 from the thumbnail motion-compensated image, which is provided by the thumbnail motion compensation section 6-1 after a motion vector search, and the reference image, estimation with good precision is possible even when a moving portion is included in an image.

Because the inputs to the second weighting estimation section 7-1 are the thumbnail original image and the thumbnail motion-compensated image, sizes of images to be processed by the second weighting estimation section 7-1 are smaller, processing is ameliorated, and a shortening of processing time is enabled.

Further, because a suitable weight and offset can be found using the least squares method, this is applicable even to a case in which X[i] and Y[i] have a negative correlation, as shown in FIG. 6. A case of changes in an image such that light portions become darker and dark portions become lighter has such a correlation. However, the moving image encoding device of the present embodiment can be applied even to such a case.

### Third Embodiment

Next, the moving image encoding device and moving image encoding method of the third embodiment will be described using FIG. 3. Structure of the present embodiment adds a third thumbnail image generation section 11 to the first embodiment. Accordingly, inputs to the second weighting estimation section 7 differ from the first embodiment.

Below, differences from the first embodiment will be described.

The third thumbnail image generation section 11 receives the motion-compensated image which is the output from the motion compensation section 6 and generates a thumbnail image thereof. Output thereof is outputted to the second weighting estimation section 7.

In the first embodiment, input of the original image to the second weighting estimation section 7 is implemented, but in the third embodiment, the thumbnail original image which is the output from the first thumbnail image generation section 2 is inputted instead. Therefore, in the third embodiment, there is no direct input from the original image input terminal 8 to the second weighting estimation section 7, which are connected in the first embodiment.

In the first embodiment, the output of the motion compensation section 6 is directly inputted to the second weighting estimation section 7, but in the third embodiment, the second weighting estimation section 7 receives the thumbnail motion-compensated image from the output of the third thumbnail image generation section 11. Therefore, in the third embodiment, there is no connection from the output of the motion compensation section 6 to the second weighting estimation section 7, as there is in the first embodiment.

—Moving Image Encoding Method—

Operations from input of the original image and the reference image until the motion-compensated image is generated are the same as in the first embodiment.

<The Third Thumbnail Image Generation Section 11>

The third thumbnail image generation section 11 receives a motion-compensated image from the motion compensation section 6 and generates a thumbnail motion-compensated image, and output thereof is outputted to the second weighting estimation section 7.

<The Second Weighting Estimation Section 7>

The second weighting estimation section 7 receives the thumbnail original image which is the output from the first thumbnail image generation section 2 and the thumbnail motion-compensated image which is the output from the third thumbnail image generation section 11, and performs a weighting estimation. Operations of the weighting estimation are the same as in the first embodiment. Results thereof, which are estimated values of a weight and an offset, are outputted to a weight and offset output terminal.

—Effects—

In the present embodiment, in addition to the effects of the first embodiment, processing at the second weighting estimation section 7 is performed using the thumbnail original image and the thumbnail motion-compensated image. Therefore, a number of processing object pixels is smaller, an increase in speed of processing can be implemented, and a further shortening of processing time can be expected.

### Fourth Embodiment

Next, the moving image encoding device and moving image encoding method relating to the fourth embodiment will be described using FIG. 7.

In the present embodiment, an effectiveness judgment section 12 and an effectiveness judgment result output terminal 13 are added to the first embodiment. Accordingly, a new output for sending statistical parameters from the second weighting estimation section 7 to the effectiveness judgment section 12 is added. Moreover, the output of the second weighting estimation section 7 is connected to the effectiveness judgment section 12 in order to send weighting parameters from the second weighting estimation section 7 to the effectiveness judgment section 12. Other structures are the same as in the moving image encoding device of the first embodiment.

With the structure described above, the moving image encoding method is as follows. Here, descriptions will be focused on differences from the first embodiment.

In the present embodiment, statistical parameters are outputted from the second weighting estimation section 7 to the effectiveness judgment section 12. The statistical parameters are the following.

x², x, xy, y

In addition, weighting parameters (a weight W0 and an offset t0) from the second weighting estimation section 7 are sent to the effectiveness judgment section 12.

The statistical parameters are calculated during estimation by the second weighting estimation section 7. New calculations for calculating these statistical parameters are not necessary.

In the effectiveness judgment section 12, a judgment parameter p is found as follows.

$$p = {\sum }_{i}^{n} {( w \times x [ i ] + t - y [ i ] )}^{2}$$

Here, n is the number of pixels in the image that is the processing object.

This expression takes on the following form.

$$p = {\sum }_{i}^{n} ( \begin{matrix}{w}^{2} \times {( x [ i ] )}^{2} - 2 w \times x [ i ] y [ i ] + \\ 2 t \times w \times x [ i ] + {( y [ i ] )}^{2} - 2 \times t \times y [ i ] + {t}^{2}\end{matrix} )$$

Accordingly, rearranging and applying the statistical parameters which have been inputted to the effectiveness judgment section 12, this takes on the following form.

$$p = {w}^{2} \times \overline{{x}^{2}} - 2 w \times \overline{xy} + 2 t \times w \times \overline{x} + {\sum }_{i}^{n} {( y [ i ] )}^{2} - 2 \times t \times \overline{y} + n \times {t}^{2}$$

It is understood that calculation volumes can be reduced by using these statistical parameters.

If p is smaller than a threshold determined beforehand, a difference between the motion-compensated image and the original image is small. That is, it can be judged that encoding volumes will be small when differences between the predicted image, which is prepared using the motion-compensated image, and the original image are encoded, and it is judged that the weighting parameters (the weight w0 and the offset t0) will be effective.

In the present embodiment, only effectiveness of the weighting parameters from the second weighting estimation section 7 is judged. However, it is of course possible to receive weighting parameters from a plurality of weighting estimation sections and judge effectiveness thereof.

When it is to be judged whether a plurality of weighting parameters are effective, suitable judgment proportions may be established such that the judgment parameter p will be small.

—Effects—

It can be judged whether or not weighting parameters that have been found will be effective for reducing encoding volumes. Therefore, in a case in which the weighting parameters will not be effective for reducing encoding volumes, encoding can be performed by applying a weighting without using the parameters, and there is no need to encode the weighting parameters themselves at the same time. Consequently, a reduction in encoding volume is enabled.

### Fifth Embodiment

Next, the moving image encoding device and moving image encoding method of the fifth embodiment will be described.

The moving image encoding device of the present embodiment is structured as shown in FIG. 8. Whereas the first weighting estimation section 4 is connected to the first thumbnail image generation section 2 and the second thumbnail image generation section 3 in the first embodiment, here the first weighting estimation section 4 is connected to the original image input terminal 8 and a first motion compensation section 15.

A motion vector search section 14 is equipped with the following processing functions.

The motion vector search section 14 performs a search for a motion vector from the original image to the reference image. The motion vector search section 14 receives the original image from the original image input terminal 8 and receives the reference image from the reference image input terminal 9, and searches for the motion vector on the basis of this data. The motion vector search section 14 outputs a motion vector resulting from the search to the first motion compensation section 15.

The first motion compensation section 15 is equipped with the following processing functions.

The first motion compensation section 15 uses the reference image and the motion vector to generate a motion-compensated image. The first motion compensation section 15 receives the reference image from the reference image input terminal 9 and receives the motion vector from the motion vector search section 14. The first motion compensation section 15 generates the motion-compensated image from the reference image and the motion vector, and outputs the motion-compensated image to the first weighting estimation section 4.

The first weighting estimation section 4 is equipped with the same processing functions as the first weighting estimation section 4 of the first embodiment.

A weighted motion vector search section 5-2 is equipped with the following processing functions.

The weighted motion vector search section 5-2 performs a search for a motion vector from the original image to the reference image. The weighted motion vector search section 5-2 receives the original image from the original image input terminal 8 and receives the reference image from the reference image input terminal 9. The weighted motion vector search section 5-2 also receives the motion vector which has not been weighted from the motion vector search section 14, and receives the estimated values of a weight and offset from the first weighting estimation section 4. The weighted motion vector search section 5-2 searches for the motion vector on the basis of this data, and outputs a weighted motion vector resulting from the search to a second motion compensation section 6-2.

The second motion compensation section 6-2 is equipped with the following processing functions.

The second motion compensation section 6-2 uses the reference image and the weighted motion vector to generate a motion-compensated image. The second motion compensation section 6-2 receives the reference image from the reference image input terminal 9 and receives the weighted motion vector from the weighted motion vector search section 5-2. The second motion compensation section 6-2 generates the motion-compensated image from the reference image and the weighted motion vector, and outputs the motion-compensated image to the second weighting estimation section 7.

The second weighting estimation section 7 is equipped with the following processing functions.

The second weighting estimation section 7 receives the motion-compensated image from the second motion compensation section 6-2 and receives the original image from the original image input terminal 8. The second weighting estimation section 7 finds a weight and an offset from the motion-compensated image and the original image. The second weighting estimation section 7 outputs the weight and the offset to a weight and offset output terminal, and outputs the weight and the offset to an encoding motion vector search section 16.

The encoding motion vector search section 16 is equipped with the following processing functions.

The encoding motion vector search section 16 performs a search for a motion vector from the original image to the reference image, for encoding. The encoding motion vector search section 16 receives the original image from the original image input terminal 8 and receives the reference image from the reference image input terminal 9. The encoding motion vector search section 16 also receives the motion vector which has not been weighted from the motion vector search section 14, receives the motion vector which has been weighted from the weighted motion vector search section 5-2, and receives the estimated values of weight and offset from the second weighting estimation section 7. The encoding motion vector search section 16 searches for the motion vector on the basis of this data, and the encoding motion vector search section 16 outputs a weighted motion vector resulting from the search to a motion vector output terminal.

Next, the moving image encoding method that uses the moving image encoding device with this structure will be described.

At the motion vector search section 14, a motion vector from the original image, from the original image input terminal 8, is searched for in the reference image inputted from the reference image input terminal 9. For this motion vector search, existing technologies may be used.

The first motion compensation section 15 takes in the motion vector from the motion vector search section 14 and the reference image from the reference image input terminal 9, and prepares a motion-compensated image from the motion vector and the reference image. For creation of this motion-compensated image, existing technologies may be used.

The first weighting estimation section 4 finds a weight and an offset from the motion-compensated image from the first motion compensation section 15 and the original image, by processing the same as the processing of the first weighting estimation section 4 in the first embodiment.

At the weighted motion vector search section 5-2, the weight w0 found by the first weighting estimation section 4 is multiplied with pixel values of the reference image inputted from the reference image input terminal 9, and the offset t0 is added thereto. Thus, a weighted reference image, which is the new pixel values, is prepared. Then, a motion vector from the original image, from the original image input terminal 8, is searched for in this new weighted reference image. For this motion vector search, existing technologies may be used.

The second motion compensation section 6-2 takes in the motion vector from the weighted motion vector search section 5-2 and the reference image from the reference image input terminal 9, and prepares a motion-compensated image from the motion vector and the reference image. For creation of this motion-compensated image, existing technologies may be used.

The second weighting estimation section 7 uses the original image from the original image input terminal 8, and uses the motion-compensated image from the second motion compensation section 6-2. The second weighting estimation section 7 finally finds a weight w1 and an offset t1 from the original image and the motion-compensated image, by processing similar to the processing of the first weighting estimation section 4.

Then, the encoding motion vector search section 16 performs a search for a motion vector of the original image for encoding. The encoding motion vector search section 16 receives the original image from the original image input terminal 8 and receives the reference image from the reference image input terminal 9. The encoding motion vector search section 16 also receives the motion vector which has not been weighted from the motion vector search section 14, receives the motion vector which has been weighted from the weighted motion vector search section 5-2, and receives the estimated values of the weight and offset from the second weighting estimation section 7. The encoding motion vector search section 16 searches for the motion vector on the basis of this data, and outputs a weighted motion vector resulting from the search, for encoding.

In the moving image encoding device and moving image encoding method described above, on the basis of the estimated values of weight and offset estimated by the first weighting estimation section 4 via the motion vector search section 14 and the first motion compensation section 15, a motion vector is searched for by the weighted motion vector search section 5-2 and, via the second motion compensation section 6-2, a weight and offset are estimated by the second weighting estimation section 7. Consequently, it is possible to predict the weight and offset accurately.

In the embodiments described above, while the least squares method is used at the first weighting estimation section 4 and the second weighting estimation section 7, this is not a limitation, and it is possible to use any widely known estimation method. That is, it is possible to use the least squares method and another method in a suitable combination. The same applies to a case in which there are three or more weighting estimation sections. In such a case, operations and effects similar to the above-described embodiments can be realized. Furthermore, the least squares method and another method may be used in combination with respect to the first thumbnail image generation section 2, the second thumbnail image generation section 3 and the third thumbnail image generation section 11.

Further, in the above-described embodiments, vertical and horizontal reduction ratios of the thumbnail images have matching values, but it is possible for the vertical and horizontal reduction ratios to be made different.

Further, in the embodiments described above, as image data reduction sections, the structures are provided with thumbnail image generation sections which create thumbnail images. However, it is also possible to reduce image data by other techniques.

Besides cases of reducing a whole image, such as to a thumbnail image, it is also possible to extract and process a portion of a whole image. For example, it is possible to divide an image between top and bottom and generate a thumbnail image for only the top half or the bottom half, in order to perform a weighting estimation. It is further possible to divide an image into four partitions and generate a thumbnail image for one or a plurality of those partitions in order to perform a weighting estimation. In a case in which image brightness or the like of a whole image would have to be processed and estimating a weighting would be difficult, a thumbnail image will be generated for the whole image, but if that characteristic is expressed in a portion of the image and a weighting could be estimated by processing only that portion, then it will be possible to extract and process that portion. Furthermore, such cases are not limited to plural partitions; portions which are particular portions of an image and are matching portions in the original image and the reference image may be extracted in order to estimate the weighting.

Further, image data reduction sections, besides cases of taking sums of plural pixels and forming reduced images as at the first thumbnail image generation section 2 and the second thumbnail image generation section 3, may perform thinning, at certain intervals, from the pixels of a whole image so as to reduce the data volume thereof. In such a case, accuracy falls somewhat, but the image data volume can be reduced while retaining characteristics of the initial image.

Further yet, a reduction ratio adjustment section may be provided which adjusts a reduction ratio of image data at the above-described image data reduction sections. For example, it is possible to connect respective reduction ratio adjustment portions which can arbitrarily adjust reduction ratios of the first thumbnail image generation section 2 and the second thumbnail image generation section 3 thereto, and arbitrarily adjust the data reduction ratios thereof. In such a case, usually, if accuracy is to fall and processing speed is to be raised, a reduction ratio is raised and a thumbnail image is made smaller. Conversely, if processing speed is to fall and accuracy is to be raised, the reduction ratio is lowered and the thumbnail images are not made much smaller. Reduction ratios are suitably adjusted by reduction ratio adjustment sections in accordance with various conditions, such as usage conditions, fields of application and the like. Accordingly, the most appropriate processing conditions may be selected for devices being employed in various conditions.

In the second embodiment, a structure such that the first weighting estimation section 4 always outputs the weighting parameters (w0,t0) to be (w0,t0)=(1,0), which is to say a structure which always outputs conditions in which there is no weighting, is possible. Such a structure is the same as a structure in which there is no first weighting estimation section 4 and the weighted thumbnail motion vector search section 5-1 searches without a weighting; obviously this structure is to be included in the present embodiments.

In the third embodiment too, a structure such that the first weighting estimation section 4 always outputs the weighting parameters (w0,t0) to be (w0,t0)=(1,0), which is to say a structure which always outputs conditions in which there is no weighting, is possible. Such a structure is the same as a structure in which there is no first weighting estimation section 4, there is no second thumbnail image generation section 3 generating input to the first weighting estimation section 4, and the weighted motion vector search section 5 searches without a weighting; obviously this structure is to be included in the present embodiments.

The above-described embodiments output the weighting parameters, but it is also possible to employ the outputted weighting parameters as inputs to the weighted motion vector search sections of the respective embodiments and perform further weighting estimations. A weighted motion vector search section which receives outputted weighting parameters need not be of the same embodiment. For example, weighting parameters which are the output of the first embodiment could be inputted to the weighted motion vector search section of the second embodiment. Furthermore, control to input outputted weighting parameters to a weighted motion vector search section may be repeated a number of times.

The above-described embodiments perform weighting estimation processing at the respective weighting estimation sections with the least squares method. However, in a case in which the weighting estimation sections are plurally provided, it is possible for one of these weighting estimation sections to use the least squares method and for another weighting estimation section to use the least squares method or another method, as appropriate. Further, it is possible to provide an effectiveness judgment section at the respective weighting estimation sections and use a judgment result of the effectiveness judgment section to implement a selection from the outputs from the plural weighting estimation sections. Accordingly, a more accurate output can be selected from the plural weighting estimation sections on the basis of the judgment result of the effectiveness judgment section, and the weighting parameters will be more accurate.

In the above-described embodiments, a moving image encoding device is structured by combining the first thumbnail image generation section 2, the second thumbnail image generation section 3, the first weighting estimation section 4, the weighted motion vector search section 5, the motion compensation section 6, the second weighting estimation section 7 and the like. However, it is possible to form a structure from only two structural elements—an image data reduction section and a weighting estimation section—or from only four structural elements—an image data reduction section, a weighted motion vector search section, a motion compensation section and a weighting estimation section—or the like. Such a structure is possible in a case in which a simple structure is desired even if accuracy will fall somewhat.

What is claimed is:

1. A moving image encoding device that encodes a difference between a predicted image and an original image, the predicted image being generated using a weighted reference image, for which a weight is multiplied with and an offset is added to a reference image, and the moving image encoding device comprising:
an image data reduction section that reduces data volumes of the original image and the reference image while retaining characteristics of the original image and the reference image; and
a weighting estimation section that estimates weighting parameters on the basis of image data of the original image and reference image of which the data volumes have been reduced by the image data reduction section.

2. The moving image encoding device of claim 1, wherein the weighting estimation section processes the image data with a least squares method.

3. The moving image encoding device of claim 1, wherein the image data reduction section includes a thumbnail image generation section that creates a thumbnail.

4. The moving image encoding device of claim 1, further comprising a reduction ratio adjustment section that adjusts a reduction ratio of the image data at the image data reduction section.

5. A moving image encoding device that encodes a difference between a predicted image and an original image, the predicted image being generated using a weighted reference image, for which a weight is multiplied with and an offset is added to a reference image, and the moving image encoding device comprising:
an image data reduction section that reduces data volumes of the original image and the reference image while retaining characteristics of the original image and the reference image;
a weighted motion vector search section that searches for a motion vector on the basis of the original image and reference image which have been reduced by the image data reduction section;
a motion compensation section that generates a motion-compensated image using the motion vector searched for by the weighted motion vector search section and the reference image; and
a weighting estimation section that estimates weighting parameters from the motion-compensated image generated by the motion compensation section and the original image.

6. The moving image encoding device of claim 5, wherein the motion compensation section performs processing on the basis of the original image data and reference image data which have been reduced by the image data reduction section.

7. The moving image encoding device of claim 5, wherein the image data reduction section includes a thumbnail image generation section that creates a thumbnail.

8. The moving image encoding device of claim 5, further comprising a reduction ratio adjustment section that adjusts a reduction ratio of the image data at the image data reduction section.

9. A moving image encoding device that encodes a difference between a predicted image and an original image, the predicted image being generated using a weighted reference image, for which a weight is multiplied with and an offset is added to a reference image, and the moving image encoding device comprising:
an image data reduction section that reduces data volumes of the original image and the reference image while retaining characteristics of the original image and the reference image;
a first weighting estimation section that estimates weighting parameters on the basis of image data of the original image and reference image of which the data volumes have been reduced by the image data reduction section;
a weighted motion vector search section that searches for a motion vector on the basis of the weighting parameters estimated by the first weighting estimation section and at least one of
the original image and reference image which have been reduced by the image data reduction section and
the original image and reference image prior to being reduced;
a motion compensation section that generates a motion-compensated image using the motion vector searched for by the weighted motion vector search section and the reference image; and
a second weighting estimation section that estimates weighting parameters from the motion-compensated image generated by the motion compensation section and the original image.

10. The moving image encoding device of claim 9, wherein the motion compensation section and the second weighting estimation section perform processing on the basis of the original image data and reference image data which have been reduced by the image data reduction section.

11. The moving image encoding device of claim 9, wherein the image data reduction section includes a thumbnail image generation section that creates a thumbnail.

12. The moving image encoding device of claim 9, wherein at least one of the first weighting estimation section and the second weighting estimation performs processing using a least squares method.

13. The moving image encoding device of claim 9, further comprising a reduction ratio adjustment section that adjusts a reduction ratio of the image data at the image data reduction section.

14. The moving image encoding device of claim 9, further comprising a motion-compensated image data reduction section that reduces a data volume while retaining characteristics of the motion-compensated image from the motion compensation section,
wherein the second weighting estimation section performs processing on the basis of image data from the motion-compensated image data reduction section and the original image data which has been reduced by the image data reduction section.

15. The moving image encoding device of claim 14, wherein the motion-compensated image data reduction section includes a thumbnail image generation section that creates a thumbnail.

16. The moving image encoding device of claim 14, further comprising a reduction ratio adjustment section that adjusts a reduction ratio of the image data at the motion-compensated image data reduction section.

17. A moving image encoding device that encodes a difference between a predicted image and an original image, the predicted image being generated using a weighted reference image, for which a weight is multiplied with and an offset is added to a reference image, and the moving image encoding device comprising:
a weighting estimation section that finds weighting parameters from the reference image and the original image with a least squares method; and
an effectiveness judgment section that judges effectiveness of a weight and offset outputted by the weighting estimation section, using a statistical quantity generated in a process of weighting calculation processing at the weighting estimation section.

18. The moving image encoding device of claim 17, further comprising:
at least one weighting estimation section, other than the weighting estimation section with the least squares method, that performs weighting estimation processing with at least one of the least squares method and a different method; and
a weighting parameter selection section that performs selection of an output from the plural weighting estimation sections, using a judgment result from the effectiveness judgment section.

19. A moving image encoding method that encodes a difference between a predicted image and an original image, the predicted image being generated using a weighted reference image, for which a weight is multiplied with and an offset is added to a reference image, and the moving image encoding method comprising:
(a) reducing data volumes of the original image and the reference image while retaining characteristics of the original image and the reference image; and
(b) estimating weighting parameters on the basis of image data of the original image and reference image of which the data volumes have been reduced in (a).

20. The moving image encoding method of claim 19, wherein (b) includes processing the image data with a least squares method.

21. The moving image encoding method of claim 19, wherein (a) includes adjusting a reduction ratio of the image data in accordance with a required processing speed and accuracy.

22. The moving image encoding method of claim 19, wherein (a) includes forming a thumbnail original image and a thumbnail reference image.

23. A moving image encoding method that encodes a difference between a predicted image and an original image, the predicted image being generated using a weighted reference image, for which a weight is multiplied with and an offset is added to a reference image, and the moving image encoding method comprising:
(a) reducing data volumes of the original image and the reference image while retaining characteristics of the original image and the reference image;
(b) searching for a motion vector on the basis of the original image and reference image which have been reduced in (a);
(c) generating a motion-compensated image using the motion vector searched for in (b) and the reference image; and
(d) estimating weighting parameters from the motion-compensated image generated in (c) and the original image.

24. The moving image encoding method of claim 23, wherein (c) includes processing on the basis of the original image data and reference image data which have been reduced in (a).

25. The moving image encoding method of claim 23, wherein (a) includes a thumbnail image generation step that creates a thumbnail.

26. The moving image encoding method of claim 23, wherein (a) includes a step of adjusting a reduction ratio of the image data in accordance with a required processing speed and accuracy.

27. A moving image encoding method that encodes a difference between a predicted image and an original image, the predicted image being generated using a weighted reference image, for which a weight is multiplied with and an offset is added to a reference image, and the moving image encoding method comprising:
(a) reducing data volumes of the original image and the reference image while retaining characteristics of the original image and the reference image;
(b) estimating weighting parameters on the basis of image data of the original image and reference image of which the data volumes have been reduced in (a);
(c) searching for a motion vector on the basis of the weighting parameters estimated in (b) and at least one of
the original image and reference image which have been reduced in (a) and
the original image and reference image prior to being reduced;
(d) generating a motion-compensated image using the motion vector searched for in (c) and the reference image; and
(e) estimating weighting parameters from the motion-compensated image generated in
(d) and the original image.

28. The moving image encoding method of claim 27, wherein (d) and (e) include processing on the basis of the original image data and reference image data which have been reduced in (a).

29. The moving image encoding method of claim 27, wherein (a) includes a thumbnail image generation step that creates a thumbnail.

30. The moving image encoding method of claim 27, wherein at least one of (b) and (e) includes processing using a least squares method.

31. The moving image encoding method of claim 27, wherein (a) includes a step of adjusting a reduction ratio of the image data in accordance with a required processing speed and accuracy.

32. The moving image encoding method of claim 27, further comprising
(f) reducing a data volume while retaining characteristics of the motion-compensated image from (d),
wherein (e) includes processing on the basis of image data from (f) and the original image data which has been reduced in (a).

33. The moving image encoding method of claim 32, wherein (f) includes a thumbnail image generation step that creates a thumbnail.

34. The moving image encoding method of claim 32, wherein (f) includes a step of adjusting a reduction ratio of the image data in accordance with a required processing speed and accuracy.

35. A moving image encoding method that encodes a difference between a predicted image and an original image, the predicted image being generated using a weighted reference image, for which a weight is multiplied with and an offset is added to a reference image, and the moving image encoding method comprising:
(a) finding weighting parameters from the reference image and the original image with a least squares method; and
(b) judging effectiveness of a weight and offset outputted by (a), using a statistical quantity generated in a process of weighting calculation processing in (a).

36. The moving image encoding method of claim 35, further comprising:
(c) other than (a) with the least squares method, performing at least one weighting estimation process with at least one of the least squares method and a different method; and
(d) selecting at least one output from (c), using a judgment result from (b).
